(19) United States
(12) Patent Application Publication
(10) Pub. No.: US 2003/0023716 A1
(43) Pub. Date: Jan. 30, 2003

(54) Method and device for monitoring the performance of a network

(76) Inventor: Aaron Joel Loyd, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/915,070

(22) Filed: Jul. 25, 2001

(51) Int. Cl. G06F 15/173

(52) U.S. Cl. 709/224

(57) ABSTRACT

An electronic network is monitored for abrupt or unexpected changes in operating parameters. Monitoring may include performing a first measurement of a parameter of the network on a first data path between a first electronic device and a second electronic device. A second measurement of the parameter may then be performed. An indication is provided if the difference of values of the first measurement and the second measurement exceeds a preselected value.

### TECHNICAL FIELD OF THE INVENTION

The present invention relates to monitoring an electronic network and, more particularly, to monitoring changes to the operation of the network over time.

### BACKGROUND OF THE INVENTION

Electronic data networks serve to electrically connect a plurality of electronic devices, such as computers, servers, and printers to one another. The electronic devices are typically connected via a plurality of switches, bridges, routers and other electronic data transfer devices. The plurality of electronic data transfer devices in a network increases the number of data paths that may be used to transfer data between different electronic devices within the network. Programming within the electronic data transfer devices determines which data path will be used between different electronic devices within the network. The data paths typically change over time to optimize data transfers within the network.

As described above, the plurality of electronic data transfer devices within the network significantly increases the complexity of the network. Networks are commonly so complex that a user of a first electronic device may transfer data to a second electronic device without knowing the data path between the devices. Likewise, the user typically does not know which electronic data transfer devices serve to transfer the data between the electronic devices. Even if the user knows which data path and electronic data transfer devices are used, they will likely change as the data paths in the network change in order to optimize data transfers between the electronic devices.

The plurality of electronic data transfer devices in a network serves to optimize data transfers, however, it also increases the difficulty in determining whether the network is operating properly. In order to determine whether the network is operating properly, a user or administrator has to determine which data path is being used between two electronic devices. The user or administrator must then measure parameters, such as response time or latency, of the data path. The parameters are then compared to preselected values to determine if the portion of the network corresponding to the measured data path is operating properly. If the network is found to be operating improperly, action must be taken in order to find the reason for the improper operation. For example, specific portions of the network may be analyzed to determine if the data transfer devices in the specific portions of the network are operating properly. If the data transfer devices are not operating properly, actions must be taken to repair the devices.

This method of determining whether the network is operating properly is difficult to implement because the parameters of a properly functioning network tend to fluctuate over time. Therefore, the above-described predetermined values of the parameters have to be very broad or they will likely be repeatedly exceeded. For example, a portion of a network may be located in an office that connects a plurality of workstations to a mail server. As the users of the workstations show up for work in the morning, they may simultaneously check their mail. Accordingly, the data paths to the mail server will have very high data traffic volumes in the morning, which may exceed preselected data traffic or latency specifications. The network, however, may be fully functional and may be operating optimally. The network just experiences heavy data traffic as the plurality of users simultaneously check their mail in the morning. During this period of heavy data traffic, an indication may be provided to the network administrator or network manager indicating that a problem exists with the network. The indication is meaningless because there is nothing an administrator can do to fix a fully operational network that is operating optimally.

A similar situation may occur if an unusually large number of users simultaneously transmit large data files via the network. The latency of the network will increase during the transmissions of the large data files and will return to normal after the transmissions have been completed. An indication of excessive traffic or latency, however, may be provided to the network administrator during this period. As with the situation described above, there is nothing a network administrator can do to resolve the problem because the network is fully operational. Accordingly, the indication is meaningless and may distract the network administrator from more serious network problems.

Therefore, a device or method is required to solve some or all of the above-described problems.

### SUMMARY OF THE INVENTION

The present invention is directed toward a method and an apparatus for monitoring the operation of an electronic network having a first electronic device operatively connected to a second electronic device. The method may comprise performing at least two measurements of a parameter of the network on a first data path between the first electronic device and the second electronic device. The method may further comprise providing an indication in response to a comparison of the measurements of the parameter. In one embodiment, the parameter may be the time response or latency of the network. In another embodiment, the parameter may be the utilization of the data paths used to operatively connect the first and second electronic devices.

Another embodiment of the present invention is directed toward a monitoring device for monitoring an electronic network having a first electronic device and a second electronic device. The monitoring device may comprise a computer operatively connected to the network and a computer-readable medium operatively associated with the computer. The computer-readable medium may contain instructions for controlling the computer and the monitoring device by performing at least two measurements of a parameter of the network on a first data path between the first electronic device and the second electronic device. The instructions may also control the device so as to provide an indication in response to a comparison of the two measurements of the parameter.

### BRIEF DESCRIPTION OF THE DRAWINGS

FIG. 1 is a block diagram of an electronic network.

FIG. 2 is a flow chart illustrating a method of monitoring the network of FIG. 1 according to one embodiment of the present invention.

FIG. 3 is a bar graph illustrating latency of the network of FIG. 1 over time.

FIG. 4 is a bar graph illustrating latency of the network of FIG. 1, wherein the network has experienced an increase in latency.

FIG. 5 is a bar graph illustrating latency of the network of FIG. 1, wherein the network has experienced an abrupt increase in latency.

FIG. 6 is a bar graph illustrating latency of the network of FIG. 1, wherein the network has experienced several abrupt increases in latency.

### DETAILED DESCRIPTION OF THE INVENTION

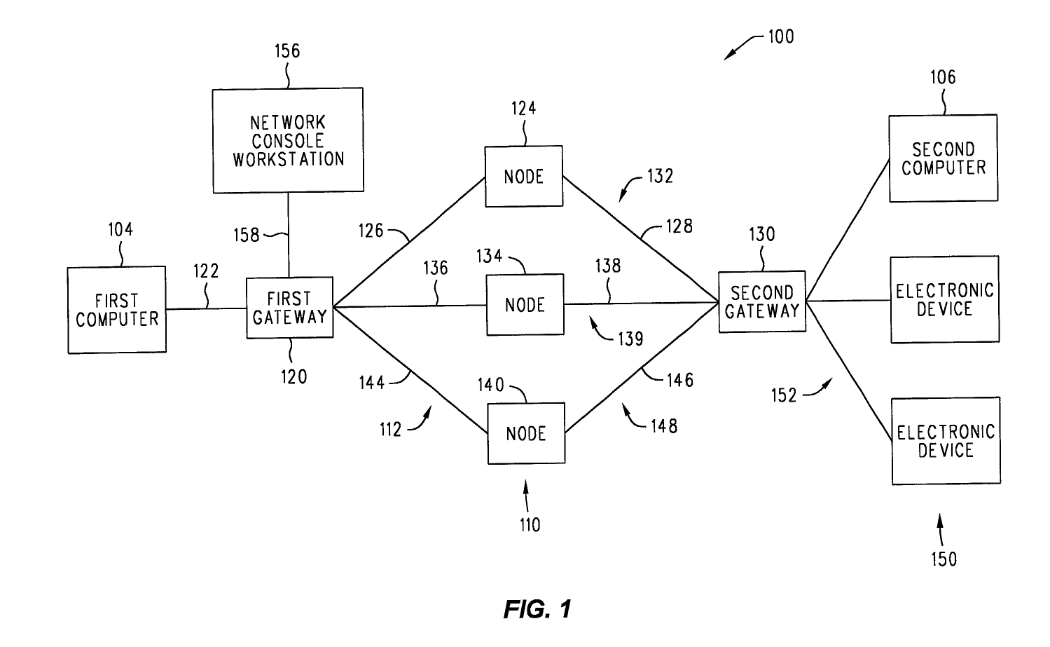

FIGS. 1 through 6, in general, illustrate a method for monitoring the operation of an electronic network 100 having a first electronic device 104 and a second electronic device 106. The method may comprise performing at least two measurements of a parameter of the network 100 on a first data path 132 between the first electronic device 104 and the second electronic device 106. The method may further comprise providing an indication in response to a comparison of the two measurements of the parameter.

FIGS. 1 through 6, also, in general, illustrate a monitoring device 156 for monitoring an electronic network 100. The electronic network 100 may be of the type comprising a first electronic device 104 and a second electronic device 106. The monitoring device may comprise a computer electrically or otherwise operatively connected to the network 100 and a computer-readable medium operatively associated (e.g., readable) with the computer. The computer-readable medium may contain instructions for controlling the computer and the monitoring device 156 by performing at least two measurements of a parameter of the network 100 on a first data path 132 between the first electronic device 104 and the second electronic device 106. The instructions may also provide an indication in response to a comparison of the at least two measurements of the parameter.

Having generally described the network 100 and the method of monitoring the network 100, they will now be described in greater detail.

A block diagram of a non-limiting example of an electronic network 100 is shown in FIG. 1. The network 100 may serve to electrically connect a plurality of electronic devices, such as computers and their associated devices, together. In the network 100 shown in FIG. 1, reference is made to a first computer 104 and a second computer 106. Methods and devices for monitoring the network 100 between the first computer 104 and the second computer 106 are described in detail below.

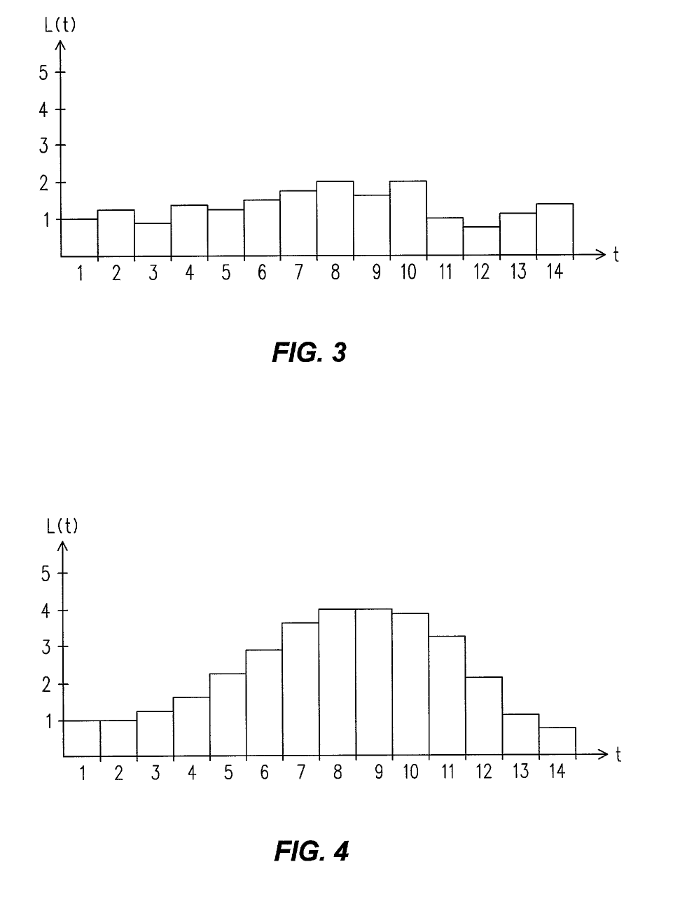

The network 100 may have a plurality of nodes 110 and hops or lines 112 connecting the nodes 110 to one another. The term “line” or “hop” used herein refers to any data transmission medium, including physical conductors or radio frequency devices and their associated components. The nodes 110 may, as examples, be routers or other electronic transfer devices as are known in the art. It should be noted that each of the nodes 110 shown in FIG. 1 may represent a plurality of these electronic data transfer devices. It should be noted that the network 100 illustrated in FIG. 3 is only an example of a network and that other networks typically have many more nodes and lines.

The first computer 104 may be operatively or otherwise electrically connected to a node 120 by a line 122. The first node 120 is sometimes referred to herein as the first gateway 120. The first gateway 120 may have several other computers, not shown, connected thereto. A node 124 may be connected to the first gateway 120 by a line 126. A line 128 may connect the node 124 to a second gateway 130. The second gateway 130 may be a node. The combination of the line 126, the node 124, and the line 128 is referenced herein as the first data path 132.

The first gateway 120 may also be connected to a node 134 by a line 136. The node 134 may, in turn, be connected to the second gateway 130 by a line 138. The combination of the line 136, the node 134, and the line 138 is referred to herein as the second data path 139. A node 140 may also be connected to the first gateway 120 by a line 144 and to the second gateway 130 by a line 146. The combination of the line 144, the node 140, and the line 146 is referred to herein as the third data path 148. The above-described data paths are used by the network 100 to transfer data between the first computer 104 and the second computer 106 in a conventional manner.

The second gateway 130 may serve to connect the above-described data paths to a plurality of electronic devices 150 by way of a plurality of lines 152. The electronic devices 150 may, as examples, be servers, printers or other electronic devices. The electronic devices 150 may all be in the same vicinity and may use the second gateway 130 to communicate with electronic devices located on the network 100, but not located within their proximity. For example, the electronic devices 150 may all be located within a single building and may use the second gateway 130 to connect all the electronic devices 150 to the network 100.

A network console workstation 156 may be connected to the network 100 by a line 158. The network console workstation 156 is shown connected to the first gateway 120, however, the network console workstation 156 may be connected to virtually any of the nodes 110 within the network 100. The network console workstation 156 may serve to monitor the network 100 and to program specific nodes within the network 100. The network 100 may use the simple network management protocol (SNMP) or other similar management protocol to communicate with the devices of the network 100. Accordingly, the network console workstation 156 is able to communicate with the nodes 110 and other electronic devices within the network 100.

Having described the layout of the network 100, the operation of the network 100 will now be described. The description of the operation of the network 100 will focus on data transmissions between the first computer 104 and the second computer 106 and is followed by a description of monitoring the operation of the network 100.

Data transmissions between the first computer 104 and the second computer 106 are accomplished by transmitting a plurality of data packets via the network 100. A data packet typically has header information followed by the data that is to be transmitted. The header information contains routing information, such as the destination of the data packet and the time to live (TTL) of the data packet. The destination information indicates the final destination of the data packet in addition to instructions relating to transmitting the data packet between different nodes 110 within the network 100. The nodes 110 may change the header information to route the data packet within the network 100 so as to optimize the data transfers. In a conventional network, a user of the network 100 is typically not made aware of changes to the header information.

The TTL information provides for the data packet to be removed from the network 100 after it has been transmitted to a preselected number of nodes 110. The header information records the nodes to which the data packet has been transmitted. When the data packet has been removed from the network, a new data packet is transmitted back to the computer or node that originated the data packet. The new data packet may, as an example, correspond to the internet control message protocol (ICMP). The time from when the data packet was transmitted to the time the second ICMP data packet is received by the originating computer is sometimes referred to as the response time. Accordingly, the originating computer or node is able to determine the path taken by the data packet in addition to the response time of the hops taken by the data packet.

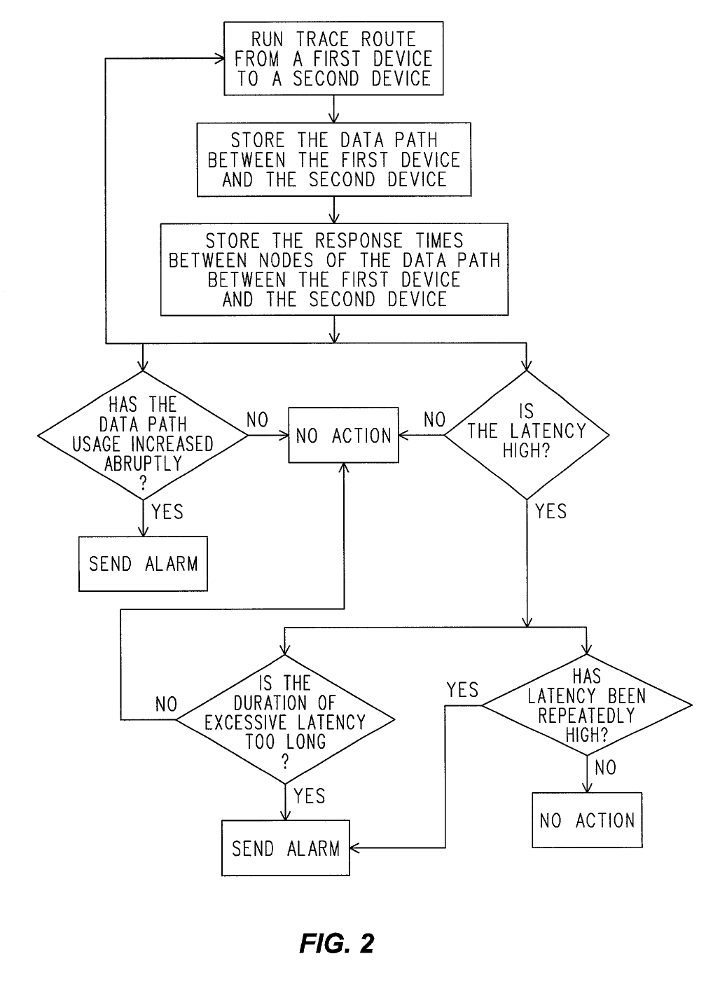

Having summarily described the operation of the network 100, a method for monitoring the network 100 will now be described. The method of monitoring the network 100 is further illustrated in the flow chart of FIG. 2.

In the example described herein, the portion of the network 100 between the first computer 104 and the second computer 106 will be monitored. It is to be understood that other portions of the network 100 may be simultaneously monitored using the monitoring methods described herein. In the non-limiting examples provided herein, the network is monitored by either or both the first computer 104 or the network console workstation 156. The monitoring is achieved by at least one program running on either or both the first computer 104 or the network console workstation 156.

The first computer 104, by way of the above-mentioned program, generates a database of data paths that are used over time for data transfers between the first computer 104 and the second computer 106. Determining which data paths are used may be achieved by operation of an internet management tool, such as a trace route routine. A trace route routine transmits a series of data packets to the second computer 106 wherein the data packets have sequentially increasing TTLs. Information regarding where the data packet terminated and the time response thereto is transmitted back to the first computer 104. The first data packet has a TTL of one and, thus, terminates at the first gateway 120. The second data packet has a TTL of two and will terminate at one of the nodes 124, 134, or 140 depending on which data path is selected by the network 100 for the transfer of data. The next data packet has a TTL of three and will terminate at the second gateway 130. Likewise, the following data packet has a TTL of four and will terminate at the second computer 106. It should be noted that, as described above, the nodes 124, 134, and 140 may actually have several nodes located therein. Accordingly, the TTL may have to be increased in order for the data packet to pass through the nodes 124, 134, 140. As each data packet is terminated, the above-described information regarding the node where the data packet was terminated is transmitted back to the first computer 104. The first computer 104 may then calculate the data path used and the response times for each of the data paths.

The information generated by the trace route routine identifies the data path to which the data packets were transmitted from the first computer 104 to the second computer 106. If the trace route routine identifies the node 124 or any of its associated components, the data packets were transmitted via the first data path 132. If the trace route routine identifies the node 134 or any of its associated components, the data packets were transmitted via the second data path 139. If the trace route routine identifies the node 140 or any of its associated components, the data packets were transmitted via the third data path 148. As the trace route routine is repeatedly run, the first computer 104 generates a database that serves to identify the historical data path use. For example, the data base may indicate that the first data path 132 is used fifty percent of the time, the second data path 139 is used thirty percent of the time, and the third data path 148 is used twenty percent of the time. It should be noted that these percentages may change during the day. For example, the second data path 139 may be used more than the first data path 132 in the morning and less than the first data path 132 in the evening.

The information generated by the trace route routine also serves to determine the response time of individual components in the data paths, which determines the latency of the data paths. Accordingly, the time response of each data path used to transmit data between the first computer 104 and the second computer 106 can be stored. As described above, this time response information may be stored in either the first computer 104 or the network console workstation 156. For illustration purposes, the information generated by the trace route routines will be described herein as being stored in the first computer 104 and may be accessed by the network console workstation 156.

The trace route routine may be run at intervals so as to create a history of the time responses of the hops and of the latency of the individual data paths within the network 100. As described above, the latency typically will not be constant over time. For example, if several users happen to be transmitting large amounts of data simultaneously, the latency of the network 100 will increase during the large data transfer. Likewise, in the situation of one of the electronic devices 150 being a mail server, there may be a lot of data transfers through the second gateway 130 in the morning when people are first checking their electronic mail. Accordingly, the latency through the second gateway 130 will be relatively high during this period.

Having described a method of determining data paths and response times, a method of analyzing the network 100 will now be described followed by examples of analyzing the network 100.

In summary, the history of network parameters, such as the time response and data path usage, may be analyzed to determine if a problem is occurring with data transfers within the network 100. Analyzing may, in part, include comparing measured parameter values to preselected parameter values. By analyzing the parameters over time, only significant problems with the network 100 will generate an alarm or notification to a network manager or administrator. Accordingly, if a network parameter exceeds a preselected specification for a very short period, it will likely not register a problem with data transfers within the network 100. For example, the latency of the network 100 may be stored to create a latency history. Under normal operating conditions of the network 100, the latency typically increases or decreases over time. Recent latency measurements are analyzed and compared to the latency history to determine if an abrupt or unexpected increase has occurred. As a further example, when the latency increases slowly or as expected in the morning due to users checking mail and the like, the increased latency will likely not trigger an alarm of a network fault.

As briefly described above, the parameters of the network 100 may be monitored over time to create a history of the parameters. Values of the parameters are compared to preselected values or thresholds that must be exceeded in order to generate an alarm signal may then be established based on the history. In one embodiment, a parameter is measured over a period of one or more time intervals. An average parameter value is then calculated. The threshold of the parameter value must be within a predetermined range of the average in order to avoid an alarm signal or notification being generated. Thus, only abrupt changes in the parameter value will cause an alarm to be generated.

In one embodiment, the above-described averaging principle is applied to response times. Some response time distributions within networks correlate to a Poisson distribution, wherein the deviation is equal the square of the mean of previous response time measurements. A preselected value or threshold may be established at three times the deviation plus the average of the samples used to derive the deviation. The measured response times are compared to the preselected value or threshold. An alarm or indication may be generated if a preselected number of consecutive time response measurements exceed the threshold. An alarm or indication may also be generated if a preselected number of time response measurements exceed the threshold over a preselected period. For example, four time response measurements may have values of ten, fifteen, eleven, and twelve. The average of the response times is twelve and the deviation is the square root of twelve, which is approximately 3.46. The threshold is then equal to twelve plus three times 3.46, which is equal to 22.39. As described above, an alarm may be generated if the following preselected number of consecutive time response measurements exceed 22.39. Likewise, an alarm may be generated if a preselected number of time response measurements exceed 22.39 over a preselected period. The subsequent time response measurements may be included into the threshold calculation to continuously update the threshold. In one embodiment, time response values that exceed the threshold are not included in the calculation to establish the new threshold value.

In another embodiment, a notification of a problem may not be generated if the latency increases for very short periods. For example, if several users transmit very large quantities of data on the network 100 for short periods, the latency of the network 100 will increase during these periods. The latency may even exceed a preselected latency specification during these periods. The latency, however, will decrease after the data has been transmitted. By analyzing the history of the network 100, it may be determined that the short periods of increased latency do not represent a problem with the network 100, but rather represent unusually high data traffic for short periods. Therefore, a notification of a problem may not be sent to the network administrator because the network is functioning properly. Should the above-described latency increases continue, an indication may be provided indicating that the capacity of the network 100 has been reached. The network 100 may then have to be modified in order to accommodate the increased data traffic.

Having described the analysis of parameters of the network 100, examples of analyzing the parameters will now be described. The following examples focus on analyzing the latency history of the network 100. The analysis of latency history is for illustration purposes only and it is to be understood that other parameters may be readily analyzed in a similar manner.

An example of the time response history or latency history of the properly functioning network 100 is shown in the bar graph of FIG. 3. The horizontal axis, t, represents a plurality of time intervals and the vertical axis represents the normalized measured latency L(t) or time response of a portion of the network 100 at the time intervals t. In the examples described herein, the time intervals may be any amount. For example, the time intervals may be seconds or hours. Each time interval is representative of an analysis or a measurement, such as the above-described time response measurements, being performed on the network 100, FIG. 1. For illustration purposes, a latency L(t) of five is representative of the network 100 operating at maximum capacity, meaning that a latency of greater than five significantly slows the operation of the network 100. In the example shown in FIG. 3, the latency L(t) tends to be between one and two. With additional reference to FIG. 1, the bar graph of FIG. 3 is representative of the normal operation of the network 100. As shown in FIG. 3, there are no significant increases in the latency L(t) of the network 100 over time. Accordingly, neither the first computer 104 nor the network console workstation 156 will generate an alarm indicating a problem with the latency of the network 100.

The situation changes somewhat in the example of the latency L(t) represented by the graph of FIG. 4. As shown in the graph of FIG. 4, the latency L(t) slowly increases and then decreases. This may be due to excessive use of the network 100, FIG. 1, for a short period. For example, if the time interval t is representative of the morning when users are arriving at their workstations, the time intervals t may collectively represent a period when users are checking their electronic mail. As described above, the latency L(t) of the network 100 will increase for a period in the morning while users check their mail. In another example, the time units of the interval t may be seconds. Accordingly, the increased latency L(t) may be due to several users simultaneously sending large amounts of data by way of the network 100.

The increase in the latency L(t) as depicted in the graph of FIG. 4 will likely not cause an alarm or notification of a network problem. The rise in latency L(t) may be expected and, thus, a preselected latency specification may be increased during this period so as to anticipate the increase. For example, the threshold for generating an alarm may be increased on a daily basis at the time the latency increase is expected in order to accommodate the expected latency increase. As described above, the latency L(t) may increase during the period that users of the network 100 are accessing their mail. The latency threshold may increase accordingly.

In another example, the latency L(t) depicted in the graph of FIG. 4 may not increase abruptly enough to cause an alarm or notification to be generated. For example, if the rise in latency L(t) from one time interval to another does not exceed a threshold, an alarm will not be generated. Likewise the increase in latency L(t) may not exceed a threshold based on previously measured response times as was described above with regard to the Poisson distribution.

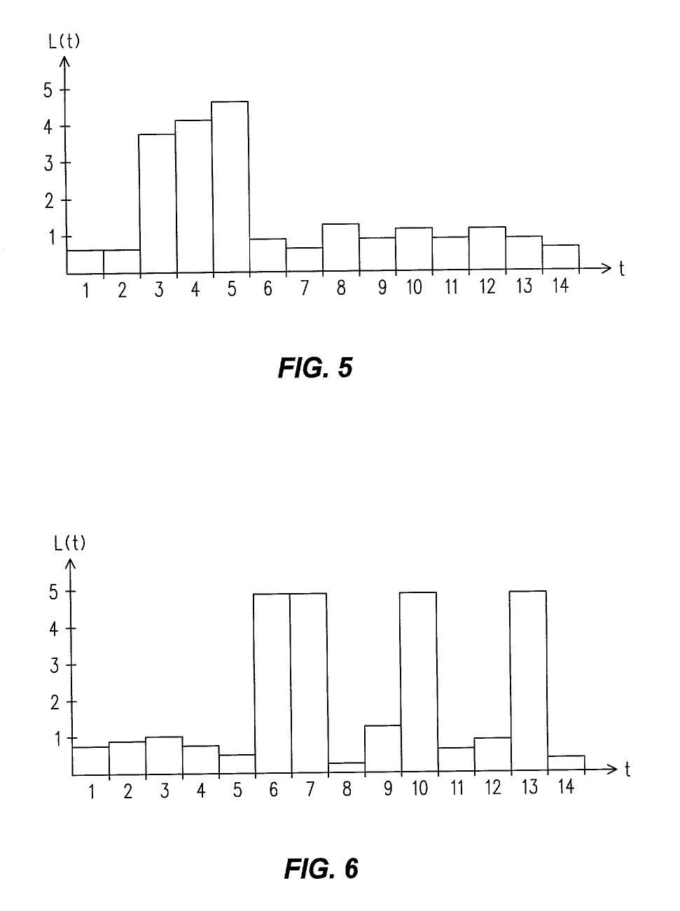

The latency L(t) of the network 100 represented by the graph of FIG. 5 shows a different circumstance than the latency L(t) depicted in the graph of FIG. 4. In the graph of FIG. 5, the latency L(t) abruptly increased during the third, fourth, and fifth time intervals. The latency L(t) then abruptly returned to approximately the values of the graph of FIG. 3. This situation may be due to several large data transfers occurring on the network 100, FIG. 1. For example, several large data transfers may have been initiated during the third time interval and may have completed by the fourth time interval. The latency L(t) represented by the graph of FIG. 5 may also be due to an inoperative data path. More specifically, if one data path becomes inoperable, the remaining data paths must accommodate the data transfers of the inoperative data path, which significantly increases the latency of the network 100.

The network monitoring program may be programmed to determine if an event as represented by the graph of FIG. 5 causes an alarm. As described above, the increase in latency L(t) as shown in the graph of FIG. 5 may be due to one of the data paths being inoperable. The increase may also be due to several users simultaneously transmitting large quantities of data by way of the network 100. The program may, as described above, have a threshold of a preselected number of consecutive time intervals that the latency L(t) may exceed a threshold before an alarm or notification is generated. In one embodiment, the alarm is generated when the latency L(t) increases abruptly and remains high for a preselected number of time intervals. For example, the program may determine whether the single latency increase represented by the graph of FIG. 5 represents a reason to generate an alarm. Accordingly, a user may select the number of time intervals that the latency threshold must be exceeded before an alarm or notification is generated.

It should be noted that if the latency L(t) rises abruptly as shown in FIG. 5 and remains high, an alarm or indication of a network fault will likely be generated. An abrupt and sustained increase in latency is generally an indication of a significant fault with the network 100. For example, several nodes 110 or hops 112 may have suddenly become completely inoperable. Accordingly, the latency of the network 100 will rise abruptly and remain high.

The latency L(t) of the network 100 represented by the graph of FIG. 6 shows a very likely cause for alarm. As shown in FIG. 6, the latency L(t) has abruptly increased several times over a short period to a point where the network 100 is being overloaded on these increases. This situation is generally not acceptable for the network 100 and is indicative of a problem with the network 100. The program may generate an alarm if the latency L(t) exceeds a threshold more than a preselected number of times within a preselected period. This situation will be detected and will cause an alarm or other notification to be provided to the network console workstation 156. One cause of the situation depicted by the graph of FIG. 6 is a fault in one of the hops 112. The functional hops 112 may be able to accommodate low amounts of data transfers. The functional hops 112 may, however, not be able to accommodate large data transfers that could normally be accommodated by the functioning network 100. Accordingly, when large quantities of data are transmitted on the network 100, the high latency periods shown in the graph of FIG. 6 occur.

Having described analyzing the latency history of the network 100, a description of analyzing the data path history will be described followed by a description of analyzing the network 100 using both latency and data path history.

As briefly described above, the information obtained by the trace route routines also include information regarding the data paths utilized between nodes within the network 100. In the examples described herein, the data paths between the first computer 104 and the second computer 106 are analyzed. The data paths used by the network 100 may be stored for a period to ascertain a data path history. The data path history may be analyzed separately or in conjunction with the latency history to ascertain whether the network 100 is experiencing a fault. For example, the history may show that the first data path 132 has been used fifty percent of the time, the second data path 139 has been used thirty percent of the time, and the third data path 148 has been used twenty percent of the time. Should one of these data paths 132, 139, 148 fail, the latency of the network 100 will increase as the functional data paths accommodate the data transfers from the nonfunctional data path. For example, should the second data path 139 fail, the usage on the first data path 132 and the third data path 148 will increase abruptly.

Upon detection of a problem, such as those illustrated by the graphs of FIGS. 4 through 6, the history of the data path usage may be analyzed. The data path history will indicate whether a data path has failed. With regard to the network 100 operating per the graph of FIG. 6, the history of the data path usage will likely indicate that an abrupt change occurred between the fifth and sixth time intervals. More specifically, the history will likely show that between the fifth and sixth time intervals one of the data paths 132, 139, 148, ceased to function properly. Accordingly, the history of the data path usage will show that the usage on one of the data paths dropped significantly and the usage on the other data paths increased significantly from a point commencing with the sixth time interval. For example, data usage history may indicate, as described above, that the usage of the first data path 132 fluctuated at about fifty percent up until the fifth time interval. From the sixth time interval, the history of usage on the first data path 132 may have dropped to about five percent. The network administrator can readily conclude that a problem exists with the first data path 132 or with routing of data packets to the first data path 132. In an alternative embodiment, the history of the data path usage may be monitored in a manner similar to the monitoring of latency. Should an abrupt and unexpected change occur in the data path usage, an alarm or notification may be generated. Such a change in the data path usage is indicative of a problem with one of the data paths or a problem in routing data packets to the data path. Referring again to FIG. 1, in one example, the network 100 may have redundant data paths between the first computer 104 and the second computer 106. The first data path 132 may be adapted to accommodate high speed data transfers and the second data path 139 and the third data path 148 may be adapted to accommodate lower speed data transfers. Thus, the first data path 132 may be used for the majority of data transfers and the second data path 139 and the third data path 148 may be used as back up data paths in case a problem occurs with the first data path 132. In this embodiment, latency will increase if the first data path 132 fails. Thus, the monitoring program may monitor the data path history to determine if there is an abrupt or unexpected change, which is indicative of a problem with one of the data paths.

In a similar embodiment, an indication may be provided if a destination within the network 100 becomes unreachable. For example, if the monitoring program determines that a response time measurement between the first computer 104 and the second computer 106 cannot be made, an indication may be provided. The program may analyze the network to determine that a problem likely exists with either the first gateway 120 or the second gateway 130.

The data path history may provide further information if a destination is not reachable. For example, if the first computer 104 cannot reach or otherwise communicate with the second computer 106, the data history may be analyzed by the program to determine the problem. An analysis may indicate that the first computer 104 is able to communicate with the first gateway 120 and no other devices further in the network 100 toward the second computer 106. The historical analysis may indicate that the first gateway 120 communicates with the node 124 exclusively. Accordingly, a problem likely exists with the node 124 and an indication to that extent may be provided.

The method of monitoring the network 100 may be performed by a computer program running on a computer connected to the network 100. For example, the network console workstation 156 may run a program that monitors the network 100 as described above. The program may have preselected values for the conditions that constitute an alarm. For example, the program may monitor the latency history and cause an alarm if latency exceeds a preselected level for a preselected period. Likewise, the alarm may occur if the latency exceeds a preselected value a number of times over a preselected period. Likewise, should the percentage of usage of a data path decrease abruptly, an alarm may occur indicating a problem with the data path.

As is evident from the above description, the program is less likely to cause meaningless error notifications than conventional network management programs. Because the history of the network operation is analyzed, the thresholds for the network operation may be changed to accommodate normal fluctuations.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method for monitoring the operation of an electronic network, said network comprising a first electronic device and a second electronic device, said method comprising:
performing a first measurement of a parameter of said network on a first data path between said first electronic device and said second electronic device;
performing a second measurement of said parameter of said network on said first data path between said first electronic device and said second electronic device;
comparing said first measurement to said second measurement; and
providing an indication in response to the comparison of said first measurement to said second measurement.

2. The method of claim 1, wherein said providing an indication comprises providing an indication if said comparison is greater than a preselected value.

3. The method of claim 1, wherein said performing a first measurement and performing a second measurement comprises performing a plurality of measurements, and wherein providing an indication comprises providing an indication if a preselected number of said measurements exceed a preselected value.

4. The method of claim 1, wherein said performing a first measurement and performing a second measurement comprises performing a plurality of measurements, and wherein said providing an indication comprises providing an indication if a preselected number of said measurements exceed a preselected value during a preselected period.

5. The method of claim 1, wherein said parameter is response time.

6. The method of claim 1, wherein said performing a first measurement and performing a second measurement comprises determining a plurality of data paths between said first electronic device and said second electronic device; and wherein said providing an indication comprises providing an indication if the use of at least one of said plurality of data paths changes more than a preselected value.

7. The method of claim 1, wherein said performing at a first measurement and performing a second measurement comprises performing a plurality of measurements of a parameter of said network on a first data path between said first electronic device and said second electronic device; and wherein said providing an indication comprises providing an indication if the value of at least one of said plurality of measurements exceeds the value of the average of previous measurements by a preselected amount.

8. The method of claim 7, wherein the values of said plurality of measurements that exceed said value of the average of previous measurements plus said preselected value are not used to calculate subsequent average values.

9. The method of claim 1, wherein said performing a first measurement and performing a second measurement comprises performing a plurality of measurements of a parameter of said network on a first data path between said first electronic device and said second electronic device, and wherein said providing an indication comprises providing an indication if the value of one of said plurality of measurements exceeds the mean of previous measurements of said parameter plus three times the square of said mean of previous measurements.

10. The method of claim 1, and further comprising determining a plurality of data paths between said first electronic device and said second electronic device; and wherein said providing an indication further comprises providing an indication if the utilization of one of said plurality of data paths changes more than a preselected value.

11. The method of claim 10, wherein said providing an indication further comprises providing an indication if the utilization of one of said plurality of data paths changes more than a preselected value a preselected number of time within a preselected period.

12. The method of claim 1, wherein said performing a first measurement and performing a second measurement comprises providing a plurality of measurements of a parameter of said network on a first data path between said first electronic device and said second electronic device, and wherein said providing an indication comprises providing an indication if the values of said plurality of measurements exceed a preselected value for a preselected period.

13. A monitoring device for monitoring an electronic network, said electronic network comprising a first electronic device and a second electronic device, said monitoring device comprising:
a computer operatively connected to said network; and
a computer-readable medium operatively associated with said computer, said computer-readable medium containing instructions for controlling said computer and said monitoring device by:
performing at least two measurements of a parameter of said network on a first data path between said first electronic device and said second electronic device; and
providing an indication in response to a comparison of said at least two measurements of said parameter.

14. The method of claim 13, wherein said providing an indication comprises providing an indication if said comparison is greater than a preselected value.

15. The method of claim 13, wherein said providing an indication comprises providing an indication if a preselected number of said measurements exceed a preselected value.

16. The method of claim 13, wherein said providing an indication comprises providing an indication if a preselected number of said measurements exceed a preselected value during a preselected period.

17. The method of claim 13, wherein said parameter is response time.

18. The method of claim 13, wherein said performing at least two measurements comprises determining a plurality of data paths between said first electronic device and said second electronic device; and wherein said providing an indication comprises providing an indication if the use of at least one of said plurality of data paths changes more than a preselected value.

19. The method of claim 13, wherein said performing at least two measurements of a parameter comprises performing a plurality of measurements of a parameter of said network on a first data path between said first electronic device and said second electronic device; and wherein said providing an indication comprises providing an indication if the value of at least one of said plurality of measurements exceeds the value of the average of previous measurements by a preselected amount.

20. The method of claim 19, wherein the values of said plurality of measurements that exceed said value of the average of previous measurements plus said preselected value are not used to calculate subsequent average values.

21. The method of claim 13, wherein said performing a measurement comprises performing a plurality of measurements of a parameter of said network on a first data path between said first electronic device and said second electronic device, and wherein said providing an indication comprises providing an indication if the value of one of said plurality of measurements exceeds the mean of previous measurements of said parameter plus three times the square of said mean of previous measurements.

22. The method of claim 13, and further comprising determining a plurality of data paths between said first electronic device and said second electronic device; and wherein said providing an indication further comprises providing an indication if the utilization of one of said plurality of data paths changes more than a preselected value.

23. The method of claim 22, wherein said providing an indication further comprises providing an indication if the utilization of one of said plurality of data paths changes more than a preselected value a preselected number of time within a preselected period.

24. The method of claim 13, wherein said performing at least two measurements comprises providing a plurality of measurements of a parameter of said network on a first data path between said first electronic device and said second electronic device, and wherein said providing an indication comprises providing an indication if the values of said plurality of measurements exceed a preselected value for a preselected period.

25. A method for monitoring the operation of an electronic network, said network comprising a first electronic device and a second electronic device, said method comprising:
measure a first response time of data transfers between said first electronic device and said second electronic device;
measuring a second response time of data transfers between said first electronic device and said second electronic device;
comparing said first response time to said second response time; and
providing an indication if said second response time exceeds said first response time by a time greater than a preselected time

26. A monitoring device for monitoring an electronic network, said network comprising a first electronic device, a second electronic device, and at least one data path extending therebetween, said monitoring device comprising:
means for repeatedly measuring a parameter of said network between said first electronic device and said second electronic device and generating measurement data indicative of said measuring;
means for receiving and comparing said measurement data to a preselected value; and
means for providing a notification in response to the comparison.
